(19) United States
(12) Patent Application Publication
(10) Pub. No.: US 2012/0170015 A1
(43) Pub. Date: Jul. 5, 2012

(54) SPECTRAL PURITY FILTER, LITHOGRAPHIC APPARATUS, METHOD FOR MANUFACTURING A SPECTRAL PURITY FILTER AND METHOD OF MANUFACTURING A DEVICE USING LITHOGRAPHIC APPARATUS

(75) Inventors: Andrei Mikhailovich Yakunin, Eindhoven (NL); Maarten Van Kampen, Eindhoven (NL); Vadim Iourievich Timoshkov, Veldhoven (NL)

(73) Assignee: ASML Netherlands B.V., Veldhoven (NL)

(21) Appl. No.: 13/496,141

(22) PCT Filed: Jul. 29, 2010
(86) PCT No.: PCT/EP10/61008

§ 371 Date: Mar. 14, 2012

Related U.S. Application Data
(60) Provisional application No. 61/242,987, filed on Sep. 16, 2009.

(51) Int. Cl. G03B 27/72; F21V 9/06; B44C 1/22

(52) U.S. Cl. 355/71; 216/24; 359/361; 355/77

(57) ABSTRACT

A spectral purity filter includes a substrate, a plurality of apertures through the substrate, and a plurality of walls. The walls define the plurality of apertures through the substrate. The spectral purity filter also includes a first layer formed on the substrate to reflect radiation of a first wavelength, and a second layer formed on the first layer to prevent oxidation of the first layer. The apertures are constructed and arranged to be able to transmit at least a portion of radiation of a second wavelength therethrough.

### CROSS-REFERENCE TO RELATED APPLICATIONS

This application claims the benefit of U.S. provisional application 61/242,987, which was filed on Sep. 16, 2009 and which is incorporated herein in its entirety by reference.

### FIELD

The present invention relates to spectral purity filters, lithographic apparatus including such spectral purity filters, methods for manufacturing spectral purity filters and methods of manufacturing a device using a lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

A key factor limiting pattern printing is the wavelength λ of the radiation used. In order to be able to project ever smaller structures onto substrates, it has been proposed to use extreme ultraviolet (EUV) radiation which is electromagnetic radiation having a wavelength within the range of 10-20 nm, for example within the range of 13-14 nm. It has further been proposed that EUV radiation with a wavelength of less than 10 nm could be used, for example within the range of 5-10 nm such as 6.7 nm or 6.8 nm. Such EUV radiation is sometimes termed soft x-ray. Possible sources include, for example, laser-produced plasma sources, discharge plasma sources, or synchrotron radiation from electron storage rings.

EUV sources based on a tin (Sn) plasma not only emit the desired in-band EUV radiation but also out-of-band radiation, most notably in the deep UV (DUV) range (100 nm-400 nm). Moreover, in the case of Laser Produced Plasma (LPP) EUV sources, the infrared (IR) radiation from the laser, usually at 10.6 μm, presents a significant amount of unwanted radiation. Since the optics of the EUV lithographic system generally have substantial reflectivity at these wavelengths, the unwanted radiation propagates into the lithography tool with significant power if no measures are taken.

In a lithographic apparatus, out-of-band radiation should be minimized for several reasons. Firstly, resist is sensitive to out-of-band wavelengths, and thus the image quality may be deteriorated. Secondly, unwanted radiation, especially the 10.6 μm radiation in LPP sources, leads to unwanted heating of the mask, wafer and optics. In order to bring unwanted radiation within specified limits, spectral purity filters (SPFs) are being developed.

Spectral purity filters can be either reflective or transmissive for EUV radiation. Implementation of a reflective SPF involves modification of an existing mirror or insertion of an additional reflective element. A reflective SPF is disclosed in U.S. Pat. No. 7,050,237. A transmissive SPF is typically placed between the collector and the illuminator and, in principle at least, does not affect the radiation path. This may be an advantage because it may result in flexibility and compatibility with other SPFs.

Grid SPFs form a class of transmissive SPFs that may be used when the unwanted radiation has a much larger wavelength than the EUV radiation, for example in the case of 10.6 μm radiation in LPP sources. Grid SPFs contain apertures with a size of the order of the wavelength to be suppressed. The suppression mechanism may vary among different types of grid SPFs as described in the prior art. Since the wavelength of EUV radiation (13.5 nm) is much smaller than the size of the apertures (typically >3 μm), EUV radiation is transmitted through the apertures without substantial diffraction.

SPFs can be coated by materials that reflect unwanted radiation from the source. Such coatings can include metals that are particularly reflective of IR radiation. However, in use, the SPFs can warm up to high temperatures of greater than 800° C. Such high temperatures in an oxidizing environment can cause the reflective coating to oxidize which leads to a reduction in its reflectivity.

### SUMMARY

It is desirable, for example, to provide a spectral purity filter that improves the spectral purity of a radiation beam and is suitable for use in an oxidizing environment at high temperatures.

According to an aspect of the invention, there is provided a spectral purity filter that includes a substrate, a plurality of apertures through the substrate, a plurality of walls, the walls defining the plurality of apertures through the substrate, a first layer formed on the substrate to reflect radiation of a first wavelength, and a second layer formed on the first layer to prevent oxidation of the first layer, wherein the apertures are constructed and arranged to be able to transmit at least a portion of radiation of a second wavelength therethrough. The substrate may be made from silicon. The first layer may cover a front surface of the substrate and the second layer may completely cover the first layer. The first layer may completely cover the substrate and the second layer may completely cover the first layer. The apertures may be elongate slits.

The plurality of apertures may be formed within a first region of the spectral purity filter and may further include a second region of the spectral purity filter that is adjacent to the first region, wherein the second region may be configured to support the walls. The first region and the second region may be formed from the substrate and the thickness of the substrate in the second region may be greater than the thickness of the substrate in the first region.

Desirably, the spectral purity filter transmits EUV radiation. The wavelength of the radiation of the second wavelength may be between about 5 nm and 20 nm. In an embodiment, the second wavelength may be about 13.5 nm.

Desirably, the spectral purity filter is configured to attenuate at least infrared (IR) radiation. The wavelength of the radiation of the first wavelength may be between about 750 nm and 100 μm, more specifically between about 1 μm and 20 μm. The wavelength of the radiation of the first wavelength may especially be about 10.6 μm, because this is a typical wavelength of CO₂ lasers.

The thickness of the second layer may be between about 0.5 nm and 20 nm. The thickness of the second layer may be about 5 nm.

According to an aspect of the invention, there is provided a lithographic apparatus including a spectral purity filter. The spectral purity filter includes a plurality of apertures, including a substrate, a plurality of walls, the walls defining the plurality of apertures through the substrate, a first layer formed on the substrate to reflect radiation of a first wavelength, and a second layer formed on the first layer to prevent oxidation of the first layer, wherein the apertures are constructed and arranged to be able to transmit at least a portion of radiation of a second wavelength therethrough. The lithographic apparatus may further include an illumination system configured to condition a radiation beam. The lithographic apparatus may further include a support configured to support a patterning device, the patterning device configured to impart the radiation beam with a pattern to form a patterned radiation beam. The lithographic apparatus may further include a projection system configured to project the patterned radiation beam onto a target portion of a second substrate.

According to an aspect of the invention, there is provided a method of manufacturing a spectral purity filter as above.

According to an aspect of the invention, there is provided a method that includes etching a plurality of apertures in a substrate using an etching process to form a grid-like filter part, wherein the apertures have a size smaller than or equal to a first wavelength of radiation to be suppressed and greater than a second wavelength of radiation to be transmitted; providing a reflective layer to substantially reflect radiation of the first wavelength; and providing a protective layer to prevent oxidation of the reflective layer, wherein the protective layer is provided over substantially all exposed surfaces of said reflective layer.

According to an aspect of the invention, there is provided a method of manufacturing a device using a lithographic apparatus comprising a spectral purity filter as above.

According to an aspect of the invention, there is provided a method of manufacturing a device using a lithographic apparatus. The method includes providing a radiation beam, patterning the radiation beam, projecting the patterned beam of radiation onto a target portion of a substrate, and enhancing the spectral purity of the radiation beam using a spectral purity filter as above.

According to an aspect, there is provided a multilayer mirror constructed and arrange to reflect EUV radiation, the multilayer mirror including a multilayer stack, a capping layer arranged to protect the multilayer stack from particles in a vicinity of the multilayer mirror and an anti-diffusion layer constructed and arranged to prevent intermixing between the multilayer stack and the capping layer. The capping layer may be formed by MoSi₂. The anti-diffusion layer may be formed by SiC. The multilayer stack may be a stack including alternating Mo and Si layers.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts the layout of a lithographic apparatus according to an embodiment of the present invention;

FIG. 3 depicts a front view of a spectral purity filter according to an embodiment of the present invention;

FIG. 4 depicts a detail of a variation of a spectral purity filter according to an embodiment of the present invention; and

FIG. 5 is a cross-sectional view of a spectral purity filter according to an embodiment of the present invention.

### DETAILED DESCRIPTION

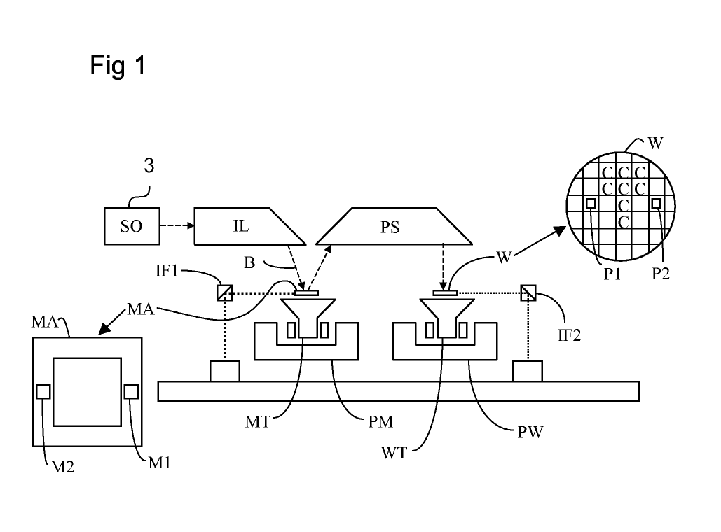

FIG. 1 schematically depicts a lithographic apparatus according to one embodiment of the invention. The apparatus comprises an illumination system (illuminator) IL configured to condition a radiation beam B (e.g. UV radiation or EUV radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Present proposals for EUV lithography employ reflective patterning devices as shown in FIG. 1. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum.

Any use of the term “projection lens” herein may be considered as synonymous with the more general term “projection system”. For EUV wavelengths, transmissive materials are not readily available. Therefore “lenses” for illumination and projection in an EUV system will generally be of the reflective type, that is to say, curved mirrors.

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system comprising, for example, suitable directing mirrors and/or a beam expander. In other cases the source may be an integral part of the lithographic apparatus, for example when the source is a mercury lamp. The source SO and the illuminator IL, together with the beam delivery system if required, may be referred to as a radiation system.

The illuminator IL may comprise an adjusting device (adjuster) configured to adjust the angular intensity distribution of the radiation beam. Generally, at least the outer and/or inner radial extent (commonly referred to as a-outer and a-inner, respectively) of the intensity distribution in a pupil plane of the illuminator can be adjusted. In addition, the illuminator IL may comprise various other components, such as an integrator and a condenser. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the mask MA with respect to the path of the radiation beam B, e.g. after mechanical retrieval from a mask library, or during a scan.

In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

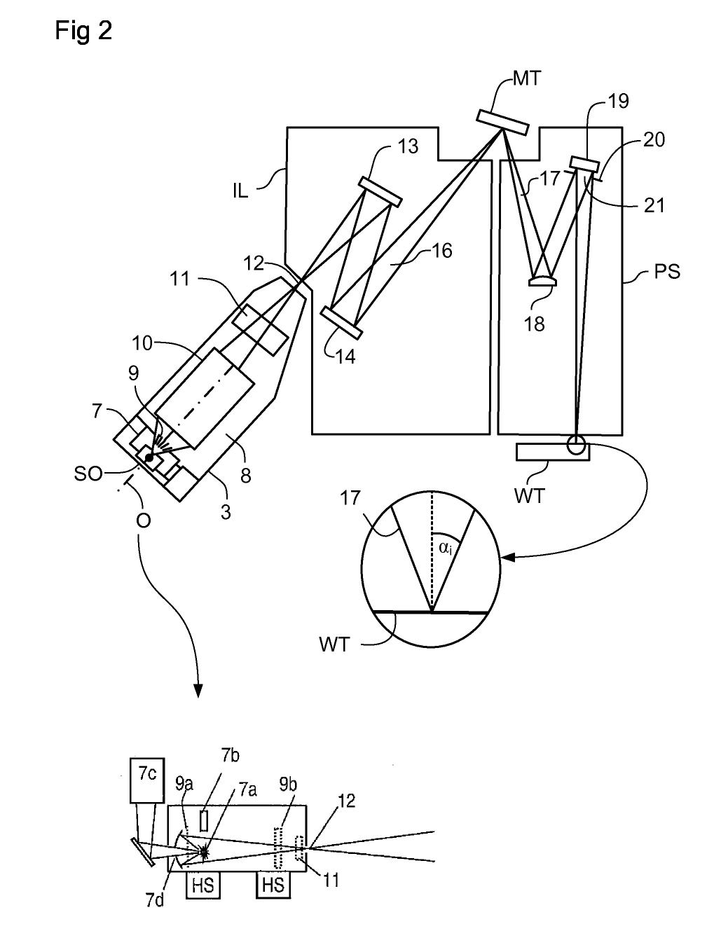

FIG. 2 depicts a schematic side view of a practical EUV lithographic apparatus. It will be noted that, although the physical arrangement is different to that of the apparatus shown in FIG. 1, the principle of operation is similar. The apparatus includes a source-collector-module or radiation unit 3, an illumination system IL and a projection system PS. Radiation unit 3 is provided with a radiation source 7, SO which may employ a gas or vapor, such as for example Xe gas or a vapor of Li, Gd or Sn in which a very hot discharge plasma is created so as to emit radiation in the EUV range of the electromagnetic radiation spectrum. The discharge plasma is created by causing a partially ionized plasma of an electrical discharge to collapse onto the optical axis O. Partial pressures of, for example, 10 Pa or 0.1 mbar of Xe, Li, Gd, Sn vapor or any other suitable gas or vapor may be desired for efficient generation of the radiation. In an embodiment, a Sn source as EUV source is applied.

The main part of FIG. 2 illustrates radiation source 7 in the form of a discharge-produced plasma (DPP). The alternative detail at lower left in the drawing illustrates an alternative form of source, using a laser-produced plasma (LPP). In the LPP type of source, an ignition region 7a is supplied with plasma fuel, for example droplets of molten Sn, from a fuel delivery system 7b. A laser beam generator 7c and associated optical system deliver a beam of radiation to the ignition region. Generator 7c may be a CO₂ laser having an infrared wavelength, for example 10.6 micrometers or 9.4 micrometers. Alternatively, other suitable lasers may be used, for example having respective wavelengths in the range of 1-11 micrometers. Upon interaction with the laser beam, the fuel droplets are transferred into plasma state which may emit, for example, 6.7 nm radiation, or any other EUV radiation selected from the range of 5-20 nm. EUV is the example of concern here, though a different type of radiation may be generated in other applications. The radiation generated in the plasma is gathered by an elliptical or other suitable collector 7d to generate the source radiation beam having intermediate focus 12.

Returning to the main part of FIG. 2, the radiation emitted by radiation source SO is passed from the DPP source chamber 7 into collector chamber 8 via a contaminant trap 9 in the form of a gas barrier or “foil trap”. This will be described further below. Collector chamber 8 may include a radiation collector 10 which is, for example, a grazing incidence collector comprising a nested array of so-called grazing incidence reflectors. Radiation collectors suitable for this purpose are known from the prior art. The beam of EUV radiation emanating from the collector 10 will have a certain angular spread, perhaps as much as 10 degrees either side of optical axis O. In the LPP source shown at lower left, a normal incidence collector 7d is provided for collecting the radiation from the source. Radiation passed by collector 10 transmits through a spectral purity filter 11 according to embodiments of the present invention. It should be noted that in contrast to reflective grating spectral purity filters, the transmissive spectral purity filter 11 does not change the direction of the radiation beam. Embodiments of the filter 11 are described below. The radiation is focused in a virtual source point 12 (i.e. an intermediate focus) from an aperture in the collection chamber 8. From chamber 8, the radiation beam 16 is reflected in illumination system IL via normal incidence reflectors 13, 14 onto a reticle or mask positioned on reticle or mask table MT. A patterned beam 17 is formed which is imaged by projection system PS via reflective elements 18, 19 onto wafer W mounted wafer stage or substrate table WT. More elements than shown may generally be present in the illumination system IL and projection system PS. One of the reflective elements 19 has in front of it an NA disc 20 having an aperture 21 therethrough. The size of the aperture 21 determines the angle αᵢ subtended by the patterned radiation beam 17 as it strikes the substrate table WT.

FIG. 2 shows the spectral purity filter 11 positioned closely upstream of the virtual source point 12. In alternative embodiments, not shown, the spectral purity filter 11 may be positioned at the virtual source point 12 or at any point between the collector 10 and the virtual source point 12. The filter can be placed at other locations in the radiation path, for example downstream of the virtual source point 12. Multiple filters can be deployed.

A contaminant trap prevents or at least reduces the incidence of fuel material or by-products impinging on the elements of the optical system and degrading their performance over time. These elements include the collector 10 and the spectral purity filter 11. In the case of the LPP source shown in detail at bottom left of FIG. 2, the contaminant trap includes a first trap arrangement 9a which protects the elliptical collector 7d, and optionally further trap arrangements, such as shown at 9b. As mentioned above, a contaminant trap 9 may be in the form of a gas barrier. A gas barrier includes a channel structure such as, for instance, described in detail in U.S. Pat. Nos. 6,614,505 and 6,359,969, which are incorporated herein by reference. The gas barrier may act as a physical barrier (by fluid counter-flow), by chemical interaction with contaminants and/or by electrostatic or electromagnetic deflection of charged particles. In practice, a combination of these methods are employed to permit transfer of the radiation into the illumination system, while blocking the plasma material to the greatest extent possible. As explained in the above-mentioned United States patents, hydrogen radicals in particular may be injected by hydrogen sources HS for chemically modifying the Sn or other plasma materials.

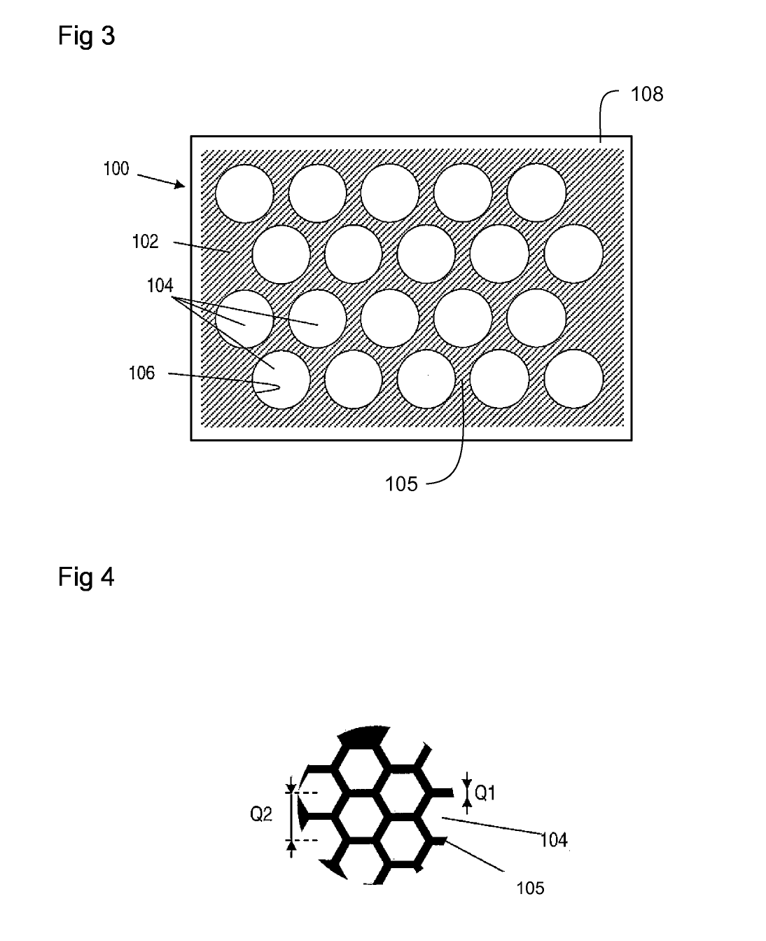

FIG. 3 is a schematic front face view of an embodiment of a spectral purity filter 100, that may for example be applied as an above-mentioned filter 11 of a lithographic apparatus. The filter 100 is configured to transmit extreme ultraviolet (EUV) radiation. In a further embodiment, the filter 100 substantially blocks a second type of radiation generated by a radiation source, for example infrared (IR) radiation, for example infrared radiation of a wavelength larger than about 1 μm, particularly larger than about 10 μm. Particularly, the EUV radiation to be transmitted and the second type of radiation (to be blocked) can emanate from the same radiation source, for example an LPP source SO of a lithographic apparatus.

The spectral purity filter 100 in the embodiments to be described comprises a substantially planar filter part 102 in a first region of the spectral purity filter. The filter part 102 has a plurality of (preferably parallel) apertures 104 to transmit the extreme ultraviolet radiation and to suppress transmission of the second type of radiation. The face on which radiation impinges from the source SO may be referred to as the front face, while the face from which radiation exits to the illumination system IL may be referred to as the rear face. As is mentioned above, for example, the EUV radiation can be transmitted by the spectral purity filter without changing the direction of the radiation. In an embodiment, each aperture 104 has sidewalls 106 defining the apertures 104 and extending completely from the front to the rear face.

The spectral purity filter 100 may include a support frame 108 in a second region of the spectral purity filter that is adjacent the first region. The support frame 108 may be configured to provide structural support for the filter part 102. The support frame 108 may include members for mounting the spectral purity filter 100 to an apparatus in which it is to be used. In a particular arrangement, the support frame 108 may surround the filter part 100.

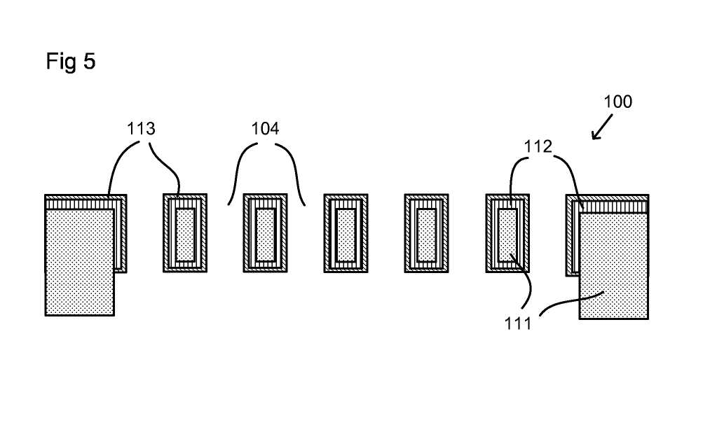

The filter 100 may include an array of apertures 104 with sidewalls 106 that are substantially perpendicular to the surface of the front face. The aperture size (i.e. the smallest distance across the front face of the aperture) is desirably larger than about 100 nm and more desirably larger than about 1 μm in order to allow EUV radiation to pass through the spectral purity filter 100 without substantial diffraction. The aperture size is desirably 10× larger than the wavelength of the radiation to be passed through the aperture and more desirably 100× larger than the wavelength of the radiation to be passed through the aperture. Although the apertures 104 are shown schematically as having a circular cross section (in FIG. 3), other shapes (for example, elongate slits, rectangles, squares, etc.) are also possible, and can be desired. For example, hexagonal apertures, as shown in FIG. 4, may be advantageous from the point of view of mechanical stability.

A wavelength to be suppressed by the filter 100 can be at least 10× the EUV wavelength to be transmitted. Particularly, the filter 100 may be configured to suppress transmission of DUV radiation (having a wavelength in the range of about 100-400 nm), and/or infrared radiation having a wavelength larger than 1 μm (for example in the range of 1-11 microns).

According to an embodiment, EUV radiation is directly transmitted through the apertures 104, preferably utilizing a relatively thin filter 100, in order to keep the aspect ratio of the apertures low enough to allow EUV transmission with a significant angular spread. The thickness of the filter part 102 (i.e. the length of each of the apertures 104) is, for example, smaller than about 20 μm, for example in the range of about 2 μm to about 10 μm. Also, according to an embodiment, each of the apertures 104 may have an aperture size in the range of about 100 nm to about 10 μm. The apertures 104 may, for example, each have an aperture size in the range of about 1 μm to about 5 μm.

The thickness Q1 of the walls 105 between the filter apertures 104 may be smaller than 1 μm, for example in the range of about 0.1 μm to about 0.5 μm, particularly about 0.4 μm. In general, the aspect ratio of the apertures, namely the ratio of the thickness of the filter part 102 to the thickness of the walls between the filter apertures 104, may be in the range of from 20:1 to 4:1. The apertures of the EUV transmissive filter 100 may have a period Q2 (indicated in FIG. 4) of in the range of about 1 μm to about 10 μm, particularly about 1 μm to about 5 μm, for example about 5 μm. Consequently, the apertures may provide an open area of about 50% to 90% of a total filter front surface.

The filter 100 may be configured to provide at most 0.01% infrared light (IR) transmission. Also, the filter 100 may be configured to transmit at least 10% of incoming EUV radiation at a normal incidence.

Desirably, the spectral purity filter is coated to maximise reflection of at least one range of unwanted wavelengths, e.g. IR wavelengths. For example, the SPF may be coated with Molybdenum (Mo). However, some materials may suffer from oxidation due to high temperatures and an oxidizing environment. This leads to a reduction in the reflective properties of the coating. For example, a reflective coating made from Mo can suffer from oxidation at temperatures above 600° C. A Mo coating can also suffer from evaporation as the oxide of Molybdenum has a much lower boiling point than the metal. The oxidation of the reflective coating can also lead to a reduction in its emissivity coefficient, which leads to a reduction in the cooling efficiency of the SPF. It is therefore desirable to provide protection against oxidation of the reflective coating.

According to an embodiment of the present invention, a SPF is provided which comprises a protective coating of the IR reflective layer. The protective coating is a thin layer of a metal silicide such as MoSi₂ or WSi₂. Metal silicides are good reflectors of IR radiation. Thus the metal silicide coating on the IR reflective coating will not significantly reduce the IR reflectivity of the spectral purity filter. For example, a MoSi₂ coating with a thickness of around 50-100 nm will reduce the IR reflectivity of a Mo reflective coating from about 95% to about 85%. A MoSi₂ coating with a thickness of around 5 nm will have a negligible effect on the IR reflectivity of the Mo reflective coating. Metal silicides have high emissivity at high temperatures (above 600° C.), which enhances the cooling of the spectral purity filter.

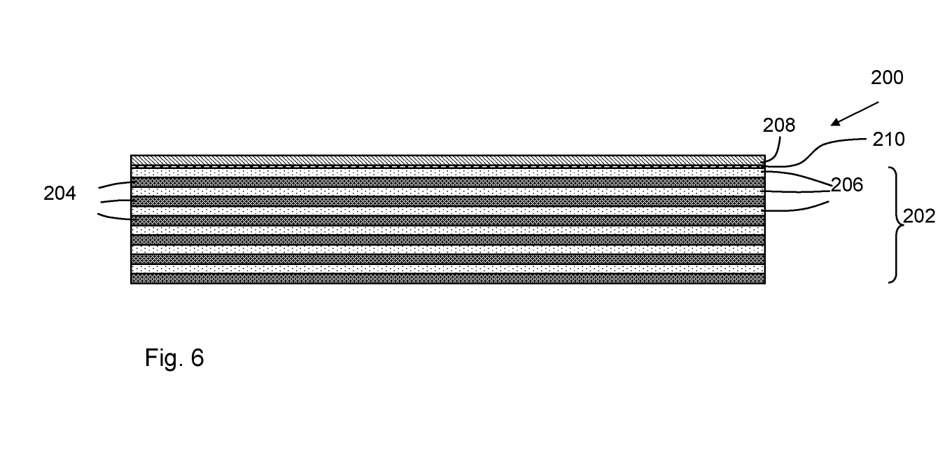

FIG. 5 depicts a cross section of a spectral purity filter according to an embodiment of the present invention. The spectral purity filter 100 comprises apertures 104. The spectral purity filter 100 comprises a substrate 111. The substrate 111 can be made from, for example, Si.

A reflective layer 112 can be formed on the surfaces of the substrate 111. As shown in FIG. 5, the reflective layer can be formed on the front face, sidewalls and the rear face in the filter part 102 to completely cover the substrate 111. The reflective layer 112 can also be formed on the front face the substrate in the support frame part 108. The reflective layer 112 can extend down the sidewall of the substrate 111 in the support part up to a required depth. Optionally, as shown in FIG. 5, the depth of the reflective layer on the sidewall of the substrate 111 in the support part is vertically level with the surface of the reflective layer 112 on the rear face of the substrate 111 in the filter part 102. The thickness of reflective layer 112 can, for example, be about 10 nm to about 200 nm. The reflective layer can be made from, for example Mo or W. The reflective coating can also be formed from a mixture of Mo and W. The reflective coating may also be formed from a mixture of W with another metal. The atomic ratio of W in the mixture can be greater than or equal to about 70%.

A protective layer 113 is formed on the surface of the reflective layer 112. As shown in FIG. 5, the protective layer 113 completely covers the reflective layer 112. The protective layer can be made from a metal silicide such as MoSi₂ or WSi₂. Typically the expansion coefficient of the substrate 111 and the metal silicide protective layer 113 differs by a factor of 2 to 3. At high temperatures, this can lead to peeling of the metal silicide protective layer 113. Thus the metal silicide protective layer 113 is made thin such that peeling is prevented. The protective layer 113 has a thickness, for example, in the range of about 0.5 nm to about 20 nm, for example the range of about 5-10 nm.

The spectral purity filter 100 can be manufactured in a number of ways. For example, the apertures in the substrate 111 can be formed by the processes described in United States Provisional Patent Application No. U.S. 61/193,769, U.S. 61/222,001, U.S. 61/222,010, U.S. 61/237,614 and U.S. 61/237,610, which are all incorporated herein in their entireties by reference.

The reflective layer 112 can be coated on to the substrate 111 by, for example, atomic layer deposition (ALD). In this way, a uniform coating thickness can be achieved. Since the thickness of the coating is uniform, a desired infrared reflectivity can be achieved with a minimal loss of EUV transmittance due to excess coating thickness. Particularly, by application of ALD, excess coating thicknesses at the top of the grid can be avoided, whilst retaining sufficient coating thickness down the sidewalls. The coating can also be applied to the rear face of the substrate 111 in the filter part 102. ALD uses alternating steps of a self-limiting surface reaction to deposit atomic layers one by one. The material to be deposited is provided through a precursor. ALD methods are known for several metals, including, for example, Mo and W.

Instead of ALD, galvanic growth (electrodeposition) may be used to deposit the reflective layer 112. Metals can also be deposited on to the substrate 111, for example by evaporation or sputter deposition.

The protective layer 113 can be deposited on to the reflective layer 112 by, for example, CVD deposition or sputtering. A MoSi₂ layer, for example, can also be formed by thermal annealing of Mo and Si layers.

A MoSi₂ layer may alternatively be used as a capping layer of a multilayer mirror. An embodiment is shown in FIG. 6. FIG. 6 discloses a multilayer mirror 200 including a multilayer stack 202 having Mo layers 204 and thick Si layers 206. One or more of the Mo layers may have a thickness of about 2.76 nm. One or more of the Si layers may have a thickness of about 4.14 nm. An uppermost layer, also referred to as the capping layer 208 is a layer formed of MoSi₂. Between the capping layer 208 and the multilayer stack 202, a so-called underlayer 210 may be provided in order to avoid intermixing, such as oxygen diffusion, between the multilayer stack 202 and the capping layer 208.

The capping layer 208 serves to protect the multilayer stack 202 from particles that may be present in its vicinity. Such particles may, for instance, be hydrogen particles and/or oxygen particles, in molecular form, atomic form or both. A MoSi₂ capping layer 208 has a suitable resistance especially against oxygen particles, but also against hydrogen particles, since it is resistant to oxidation up to 1600° C. MoSi₂ has a melting point of 2030° C. and a low density. Other than 1 oxide monolayer no volume oxidation will occur.

Instead of MoSi₂, other materials may be used as a capping layer, such as Ru or SiC. Instead of SiC, other materials may be used as an underlayer, such as Si₃N, B₄C or MoSi₂.

Table 1 discloses a calculated reflectivity of different capping layers and underlayers in combination with the aforementioned multilayer stack formed by about 50 layers of 2.76 nm thick Mo and 4.14 nm thick Si layers.

TABLE 1
Calculated reflectivity for different capping layers and underlayers.

| | Thickness | | Thickness | Max reflectivity |
|---|---|---|---|---|
| Capping layer | (nm) | Underlayer | (nm) | (%) |
| Ru | 1.7 | Si₃N₄ | 0.15 | 75.72 |
| Ru | 1.7 | B₄C | 0.16 | 75.71 |
| MoSi₂ | 1.7 | Si₃N₄ | 0.2 | 75.06 |
| SiC | 0.4 | Si₃N₄ | 0.8 | 74.82 |
| MoSi₂ | 1.76 | SiC | 0.17 | 75.06 |
| SiC | 0 | MoSi₂ | 1.92 | 75.05 |

As can be seen in the table, the calculated reflectivity for MoSi₂ as a capping layer 208 in combination with SiC as an underlayer 210 is expected to be only marginally less reflective than a capping layer 208 of Ru.

The multilayer mirror 200 may be included in the illuminator IL or the projection system PS. Alternatively or additionally, it may be the collector 7d.

Also, the multilayer stack 202 may be modified. It may include anti-diffusion barriers between some or all of the Si layers 204 and some or all of the Mo layers 206. A suitable material for such an anti-diffusion barrier may be B₄C or B₉C. Moreover, the layers 204, 206 may be formed by materials other than Si and Mo.

It will be understood that the apparatus of FIGS. 1 and 2 incorporating the spectral purity filter may be used in a lithographic manufacturing process. Such lithographic apparatus may be used in the manufacture of ICs, integrated optical systems, guidance and detection patterns for magnetic domain memories, flat-panel displays, liquid crystal displays (LCDs), thin-film magnetic heads, etc. It should be appreciated that, in the context of such alternative applications, any use of the term “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The descriptions above are intended to be illustrative, not limiting. Thus, it should be appreciated that modifications may be made to the present invention as described without departing from the scope of the claims set out below.

It will be appreciated that embodiments of the invention may be used for any type of EUV source, including but not limited to a discharge produced plasma source (DPP source), or a laser produced plasma source (LPP source). However, an embodiment of the invention may be particularly suited to suppress radiation from a laser source, which typically forms part of a laser produced plasma source. This is because such a plasma source often outputs secondary radiation arising from the laser.

The spectral purity filter maybe located practically anywhere in the radiation path. In an embodiment, the spectral purity filter is located in a region that receives EUV containing radiation from the EUV radiation source and delivers the EUV radiation to a suitable downstream EUV radiation optical system, wherein the radiation from the EUV radiation source is arranged to pass through the spectral purity filter prior to entering the optical system. In an embodiment, the spectral purity filter is in the EUV radiation source. In an embodiment, the spectral purity filter is in the EUV lithographic apparatus, such as in the illumination system or in the projection system. In an embodiment, the spectral purity filter is located in a radiation path after the plasma but before the collector.

Although specific reference may be made in this text to the use of lithographic apparatus in the manufacture of ICs, it should be understood that the lithographic apparatus described herein may have other applications in manufacturing components with microscale, or even nanoscale, features, such as the manufacture of integrated optical systems, guidance and detection patterns for magnetic domain memories, flat-panel displays, liquid-crystal displays (LCDs), thin-film magnetic heads, etc.

While specific embodiments of the present invention have been described above, it should be appreciated that the present invention may be practised otherwise than as described.

1. A spectral purity filter, comprising:
a substrate;
a plurality of apertures through the substrate;
a plurality of walls, the walls defining the plurality of apertures through the substrate;
a first layer formed on the substrate to reflect radiation of a first wavelength; and
a second layer formed on the first layer to prevent oxidation of the first layer;
wherein the apertures are constructed and arranged to be able to transmit at least a portion of radiation of a second wavelength therethrough.

2. A spectral purity filter according to claim 1, wherein the apertures form a patterned array.

3. A spectral purity filter according to claim 1, wherein the apertures have a circular cross section.

4. A spectral purity filter according to claim 1, wherein the apertures have a hexagonal cross section.

5. A spectral purity filter according to claim 1, wherein the first layer extends from a front surface of the substrate and down the walls of the apertures to the same vertical level.

6. A spectral purity filter according to claim 1, wherein the first layer is made from a material selected from a group consisting of Mo and W.

7. A spectral purity filter according to claim 1, wherein the first layer is made from a mixture of W and a metal, and wherein the atomic ratio of W in said mixture is greater than about 70%.

8. A spectral purity filter according to claim 1, wherein the second layer is made from a metal silicide.

9. A spectral purity filter according to claim 1, wherein the second layer is made from a material selected from a group consisting of MoSi₂ and WSi₂.

10. A spectral purity filter according to claim 1, wherein second layer is thin such that peeling is prevented at high temperatures.

11. A spectral purity filter according to claim 1, wherein the second layer prevents oxidation of the first layer at temperatures up to 1400° C.

12. A lithographic apparatus comprising: a spectral purity filter, the spectral purity filter comprising
a substrate;
a plurality of apertures through the substrate;
a plurality of walls, the walls defining the plurality of apertures through the substrate;
a first layer formed on the substrate to reflect radiation of a first wavelength; and
a second layer formed on the first layer to prevent oxidation of the first layer;
wherein the apertures are constructed and arranged to be able to transmit at least a portion of radiation of a second wavelength therethrough.

13. A method of manufacturing a spectral purity filter comprising:
etching a plurality of apertures in a substrate using an etching process to form a grid-like filter part, wherein the apertures have a size smaller than or equal to a first wavelength of radiation to be suppressed and greater than a second wavelength of radiation to be transmitted;
providing a reflective layer to substantially reflect radiation of the first wavelength; and
providing a protective layer to prevent oxidation of the reflective layer, wherein the protective layer, such as a protective layer made from MoSi₂ or WSi₂, is provided over substantially all exposed surfaces of said reflective layer.

14. (canceled)

15. A method of manufacturing a device using a lithographic apparatus, comprising:
enhancing the spectral purity of a radiation beam using a spectral purity filter comprising
a substrate,
a plurality of apertures through the substrate;
a plurality of walls, the walls defining the plurality of apertures through the substrate,
a first layer formed on the substrate to reflect radiation of a first wavelength, and
a second layer formed on the first layer to prevent oxidation of the first layer,
wherein at least a portion of radiation of a second wavelength is transmitted through the apertures;
patterning the radiation beam; and
projecting the patterned beam of radiation onto a target portion of a second substrate.
